(19) United States
(12) Patent Application Publication
(10) Pub. No.: US 2026/0152299 A1
(43) Pub. Date: Jun. 4, 2026

(54) UNMANNED AERIAL VEHICLE

(71) Applicant: Arashi Vision Inc., Shenzhen, Guangdong (CN)

(72) Inventors: Guilin ZHANG, Shenzhen, Guangdong (CN); Fei GAO, Shenzhen, Guangdong (CN)

(73) Assignee: Arashi Vision Inc., Shenzhen, Guangdong (CN)

(21) Appl. No.: 18/963,831

(22) Filed: Nov. 29, 2024

Related U.S. Application Data
(63) Continuation of application No. PCT/CN2023/098871, filed on Jun. 7, 2023.

(30) Foreign Application Priority Data
Jun. 13, 2022 (CN) 202221474387.0

(51) Int. Cl. B64U 20/87; B64D 47/08; B64U 101/30

(52) U.S. Cl. CPC B64U 20/87; B64D 47/08; B64U 2101/30

(57) ABSTRACT

A UAV may include arms and a lens assembly. The lens assembly may include a first lens and a second lens. The first lens may protrude from a top of a fuselage of the UAV so that the arms are outside an angle of view of the first lens and the second lens may protrude from a bottom of the fuselage of the UAV so that the arms are outside an angle of view of the second lens.

### CROSS-REFERENCE TO RELATED APPLICATIONS

The present application is a continuation of International Application No. PCT/CN2023/098871, filed on Jun. 7, 2023, which claims the priority of Chinese Patent Application No. CN 202221474387.0, filed on Jun. 13, 2022, the content of each of which is incorporated herein by reference in its entirety.

### TECHNICAL ANGLE

The present disclosure relates to the technical field of panoramic lenses for unmanned aerial vehicles (UAVs), and particularly relates to a UAV.

### BACKGROUND

For a UAV having single fisheye lens, the shooting perspective is relatively limited. In order to realize panoramic imaging, multiple fisheye lenses are usually used. However, due to special characteristics of the structure of the UAV body (the UAV body is generally provided with four arms and multiple paddles), it is easy for the UAV body to block or obstruct the angle of view of the lens, which affects the quality of panoramic imaging.

In the related art, as shown in FIG. 1, a UAV equipped with fisheye lenses is usually set up with a top fisheye lens 1a and a bottom fisheye lens 2a coaxially and fixed in the vertical direction 100. As such, the angles of view of the two lenses are easily blocked by the paddles, the landing gears 3a, or the fuselage of the UAV, which have a wide range of obstruction and affect the quality of shooting. In order to avoid the above obstruction, the lenses are generally highly elevated and moved away from the fuselage. However, this approach tends to sacrifice appearance. Furthermore, the highly elevated lens increases the air resistance of the UAV in flight, and it is easy for the protruding lens to be bumped or worn out.

### SUMMARY

One purpose of the present disclosure is to overcome deficiencies of the above mentioned prior art, and provide a UAV that effectively eliminates or reduces the extent of the first lens and the second lens whose angles of view being blocked, and also makes the extents of the lenses protruding out of the UAV body smaller, thereby better protecting the lenses so that it is not easy for them to be bumped and worn.

One embodiment of the present disclosure provides a UAV. The UAV may include a UAV body and a lens assembly. The UAV body may include a fuselage, a first set of arms at one end of the fuselage in a lengthwise direction and a second set of arms at the other end of the fuselage in the lengthwise direction, the first set of arms being closer to a top of the fuselage relative to the second set of arms. The lens assembly may include a first lens and a second lens, the first lens protruding from the top of the fuselage so that the first set of arms is outside an angle of view of the first lens and the second lens protruding from a bottom of the fuselage so that the second set of arms is outside an angle of view of the second lens.

One embodiment of the present disclosure provides a UAV, the first set of arms being closer to the top of the UAV body with respect to the second set of arms; the UAV body being located outside the angles of view of the first lens and the second lens by providing a first lens and a second lens, the first lens being provided at the top of the fuselage and the second lens being provided at the bottom of the fuselage; the first lens protrudes from the top of the UAV body and the first lens is closer to the first set of arms relative to the second lens, and the second lens protrudes from the bottom of the UAV body and the second lens is closer to the second set of arms; and that by the first set of arms and the second set of arms not being disposed flush with each other and by varying the specific positions of the first lens and the second lens relative to the first set of arms and the second set of arms so as to cause the UAV body to be outside the angles of view of the first lens and the second lens, so that the angles of view of the first lens and the second lens are not blocked, or the extent of being blocked can be minimized, and the extent of the lens (the first lens and the second lens) protruding from the UAV body (the fuselage) is reduced to protect the lens from being easily bumped and worn.

It should be understood that the above general description and the detailed description that follows are exemplary and explanatory only and do not limit the present application.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a schematic diagram of a structure of a UAV in the related art;

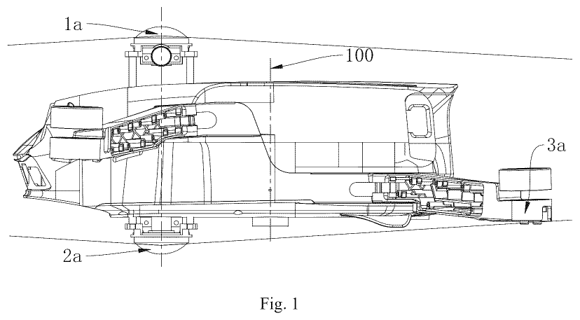

FIG. 2 is a schematic diagram of a structure of a UAV provided by an embodiment of the present disclosure;

FIG. 3 is a schematic diagram of a structure of a UAV provided by another embodiment of the present disclosure.

Symbols in the figure:
1a—top fisheye lens, 2a-bottom fisheye lens, 100—vertical direction;
1—first lens, 2—second lens, 3—landing gear, 4—first set of arms, 5—second set of arms, 6—fuselage, 200—longitudinal axis.

### DETAILED DESCRIPTION

In order to make the purpose, technical solution and advantages of the present disclosure more clearly understood, the present disclosure is described in further detail hereinafter in conjunction with the accompanying drawings and embodiments. It should be understood that the specific embodiments described herein are only for explaining the present disclosure and are not intended to limit the present disclosure.

It should be noted that the terms “provided,” “fixed,” and “connected” are to be understood in a broad sense, for example, either directly or indirectly through intermediary components or intermediary structures.

In addition, in the embodiments of the present disclosure, if there are terms indicating orientation or positional relationships such as “longitudinal”, “transverse”, “length”, “width”, “thickness”, “up”, “down”, “front”, “back”, “left”, “right”, “vertical”, “horizontal”, “top”, “bottom”, “inside”, and “outside”, they are based on the orientation or positional relationships or the conventional placement state or usage state shown in the drawings, and are only for the convenience of describing the present disclosure and simplifying the description, and do not indicate or imply that the structure, feature, device or element referred to must have a specific orientation or positional relationship, nor must it be constructed and operated in a specific orientation, and therefore cannot be understood as a limitation in the present disclosure. In the description of the present disclosure, unless otherwise indicated, “plurality” means two or more.

Each specific technical feature and each embodiment described in the specific embodiments can be combined in any suitable way in case of no contradiction. For example, different embodiments can be formed by the combination of different specific technical features/embodiments, and in order to avoid unnecessary repetitions, the various possible ways of combining the specific technical features/embodiments in the present disclosure are not separately described.

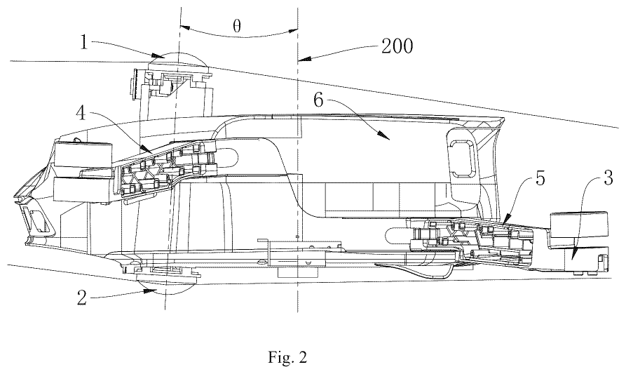

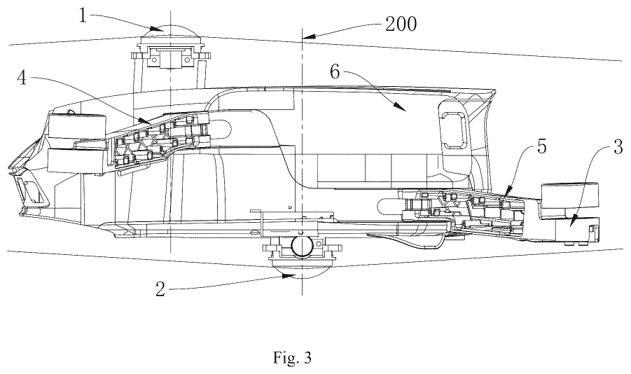

As shown in FIGS. 2 and 3, one embodiment of the present disclosure provides a UAV comprising a UAV body and a lens assembly, the UAV body comprising a fuselage 6, a first set of arms 4 disposed at one end of the fuselage 6, and a second set of arms 5 disposed at the other end of the fuselage 6 in a lengthwise direction; In one embodiment, the first set of arms 4 is closer to one side of the fuselage in the fuselage length direction relative to the second set of arms 5; the one side of fuselage in the fuselage length direction may be a nose or tail of the UAV; the first set of arms may be in front of the nose of the done or at both sides of the fuselage and close to the nose of the done; the second set of arms may be behind the tail of the UAV or at both sides of the fuselage and close to the tail of the UAV.

A horizontal distance between a base of the first set of arms and a base of the second set of arms in a length direction is not particularly limited. In one embodiment, for a relatively small UAV, a horizontal distance between a base of the first set of arms and a base of the second set of arms in a length direction is in a range of 50 mm to 70 mm. In another embodiment, for a relatively large UAV, a horizontal distance between a base of the first set of arms and a base of the second set of arms in a length direction is in a range of 80 mm to 150 mm.

In one embodiment, the first set of arms 4 is closer to the top or upper end of the fuselage 6 with respect to the second set of arms 5. The first lens 1 protrudes from the upper end of the fuselage 6, and the first lens 1 is closer to the first set of arms 4 relative to the second lens 2. The second lens 2 protrudes from the bottom or lower end of the fuselage 6 and is closer to the second set of arms 5 relative to the first lens 1. The lens assembly includes a first lens 1 and a second lens 2, wherein the first lens 1 is arranged at the top of the UAV body, and the second lens 2 is arranged at the bottom of the UAV body, so that the UAV body is located outside the angles of view of the two panoramic lenses. In one embodiment, the angle of view of each of the panoramic lenses is at least 185°. In one embodiment, the angle of view of each of the panoramic lenses is in a range of 185° to 210°. By means of the reasonable layout of the first set of arms 4 and the second set of arms 5, under the premise of ensuring a smooth and reliable flight, the angles of view of the first lens 1 and the second lens 2 are not to be blocked, or the scope of the panoramic lenses being blocked is minimized.

In one embodiment, the UAV body has a longitudinal axis 200 along the height direction of the fuselage 6. When the fuselage flies horizontally or positioned horizontally relative to a horizontal plane, the longitudinal axis 200 is perpendicular to the horizontal plan. The axis of the first lens 1 or the axis of the second lens 2 is inclined relative to the longitudinal axis 200 so that the UAV body is located outside the angles of view of the first lens 1 and the second lens 2. Alternatively, the axis of the first lens 1 and the axis of the second lens 2 are both inclined relative to the longitudinal axis 200 so that the UAV body is located outside the angles of view of the first lens 1 and the second lens 2. In a UAV provided by one embodiment of the present disclosure, by changing the relative positions and settings of the first lens 1 and the second lens 2 so that the UAV body is located outside the angles of view of the first lens 1 and the second lens 2. Such configuration can effectively minimize the scope of the angles of view of the first lens 1 and the second lens 2 being blocked, if any. It also makes the extent of lenses (the first lens 1 and the second lens 2) protruding from the fuselage (the UAV body) smaller, which can better protect the lenses so that they are not easy to be bumped and worn.

In one embodiment, as shown in FIG. 2, the first lens 1 and the second lens 2 are coaxially provided, and the axis of the first lens 1, and the axis of the second lens 2 are inclined relative to the longitudinal axis 200. The axis of the first lens 1 is provided inclined relative to the longitudinal axis 200 in the direction from the first set of arms 4 to the set of arms 5. The angle between the axis of the first lens 1 or the axis of the second lens 2 and the longitudinal axis 200 is 2 to 10 degrees or 4 to 8 degrees. In a specific application, the UAV may comprise a connecting member or connector, one end of the connecting member is connected to the first lens 1, and the other end of the connecting member is connected to the second lens 2. Optionally, the connecting member may comprise a connecting shaft and a positioning member or positioner, the two ends of the connecting shaft are connected to the first lens 1 and the second lens 2, respectively; the positioning member disposed in the UAV body is used to fix the connecting shaft. The positioning member may be a threaded structure, the threaded structure being used to abut against the connecting shaft. The UAV body has a through hole through which the threaded structure can pass. In one embodiment, the connecting member is used to make the first lens 1 and the second lens 2 coaxial, and the inclination angle θ between the connecting shaft relative to the longitudinal axis 200 is fixed via the limiting effect of the positioning member. In one embodiment, the threaded structure is a bolt, the bolt passes through the through hole and against the connecting shaft, and the inclination angle θ is adjustable (in this embodiment, it is 3.2°) to effectively minimize or eliminate the extent of the angles of view of the first lens 1 and the second lens 2 being blocked, and it is convenient to make the adjustment.

In one embodiment, the axis of the first lens 1 and the axis of the second lens 2 are not coaxially arranged. The axis of the first lens 1 is set inclined with respect to the longitudinal axis 200 in the direction from the first set of arms 4 to the second set of arms 5. In one embodiment, the axis of the second lens 2 is provided in the direction of the longitudinal axis 200. Specifically, the axis of the first lens 1 is relatively inclined with respect to the longitudinal axis 200, and the inclination direction is the direction from the first set of arms 4 to the second set of arms 5. The axis of the second lens 2 is provided in the direction of the longitudinal axis 200; in another embodiment, the axis of the first lens 1 is relatively inclined with respect to the longitudinal axis 200, and the axis of the second lens 2 is relatively inclined with respect to the longitudinal axis 200; in specific applications, the adjustment can be made according to the actual needs so that the angles of view of the first lens 1 and the second lens 2 are not blocked or the scope of being blocked is minimized.

In one embodiment, the axis of the first lens 1 and the axis of the second lens 2 are not coaxially arranged, and the axis of the second lens 2 is set inclined with respect to the longitudinal axis 200 in the direction of from the first set of arms 4 to the second set of arms 5. The axis of the first lens 1 is provided in the direction of the longitudinal axis 200. In specific applications, adjustments can be made according to actual needs so that the angles of view of the first lens 1 and the second lens 2 are not blocked or the extent of being blocked is minimized.

In one embodiment, the UAV body has a longitudinal axis 200 along the height direction of the fuselage 6, and it is to be understood that when the UAV body flies or is placed horizontally relative to the horizontal plane, the longitudinal axis 200 is perpendicular to the horizontal plane. The axis of the first lens 1 and the axis of the second lens 2 are parallel to the longitudinal axis 200, and the first lens 1 and the second lens 2 are spaced apart along the planar direction of the UAV body (i.e., perpendicular to the planar direction of the longitudinal axis 200) so that the UAV body is located outside of the angles of view of the first lens 1 and the second lens 2. As shown in FIG. 3, the first lens 1 and the second lens 2 are spaced apart along a direction perpendicular to the longitudinal axis 200. It can be understood that the direction perpendicular to the longitudinal axis 200 is a length direction of the fuselage when the UAV body is flying horizontally or placed horizontally relative to the horizontal plane. The axis of the first lens 1 and the axis of the second lens 2 are both parallel to the longitudinal axis 200. In specific applications, the spacing between the first lens 1 and the second lens 2 can be flexibly set to satisfy that the angles of view of the first lens 1 and the second lens 2 are not blocked or the scope of the angles of view being blocked is minimized. In one embodiment, a distance between the first lens 1 and the second lens 2 in a length direction is in a range of 40 mm to 160 mm.

In one embodiment, the UAV body comprises a landing gear 3 that can be retracted, the landing gear 3 when retracted being located outside the angles of view of the first lens 1 and the second lens 2. Optionally, the retractable landing gear 3 also does not affect the shooting angle of view. In one embodiment, the UAV body comprises paddles, the paddles are also located outside the angles of view of the first lens 1 and the second lens 2 so as to satisfy the need for more shooting scenes.

In one embodiment, a boundary of the angle of view of the first lens 1 is tangent to the UAV body; or a boundary of the angle of view of the second lens 2 is tangent to the UAV body. It is to be understood that the boundary of the angle of view of the first lens 1 refers to the boundary of the maximum angle of view of the first lens 1, and the boundary of the angle of view of the second lens 2 refers to the boundary of the maximum angle of view of the second lens 2; and, in this embodiment, by changing the relative position and setting of the first lens 1 and the second lens 2 in such a way so that the boundary of the maximum angle of view of the first lens 1 is tangent to the UAV body and the boundary of the maximum angle of view of the second lens 2 is tangent to the UAV body to obtain maximum angles of view without being obscured by the UAV body. In one embodiment, the maximum angle of view of the first lens or the second lens is in a range of 185° to 210°.

An embodiment of the present disclosure provides a UAV. For the UAV, the first set of arms 4 is closer to the top of the fuselage than the second set of arms 5; By setting a first lens 1 and a second lens 2, the first lens 1 is set at the top of the UAV body, and the second lens 2 is set at the bottom of the UAV body, so that the UAV body is located outside the angles of view of the two panoramic lenses (the first lens 1 and the second lens 2). The first lens 1 protrudes from the top or upper end of the fuselage, and the first lens 1 is closer to the first set of arms 4 relative to the second lens 2. The second lens 2 protrudes from the bottom or lower end of the fuselage, and the second lens 2 is closer to the second set of arms 5. By arranging the first set of arms 4 and the second set of arms 5 unevenly in the longitudinal direction and changing the specific positions of the first lens 1 and the second lens 2 relative to the first set of arms 4 and the second set of arms 5, the UAV body is located outside the angles of view of the of the first lens 1 and the second lens 2, so that the angles of view of the first lens 1 and the second lens 2 are not blocked, or the extent of being blocked is minimized, and the extent of the lenses (the first lens 1 and the second lens 2) protruding from the UAV body (fuselage) is reduced, thereby better protecting the lenses from being easily bumped and worn.

The above are some embodiments of the present disclosure, and are not intended to limit the present disclosure, and any modifications, equivalent replacements or improvements made within the spirit and principles of the disclosure shall be included in the scope of protection of the disclosure.

The above-described embodiments express only several embodiments of the present application, which are described in a more specific and detailed manner, but are not to be construed as a limitation of the scope of the patent of the present application. It should be pointed out that for a person of ordinary skill in the art, several modifications and improvements can be made without departing from the conception of the present application, which all fall within the scope of protection of the present application. Therefore, the scope of protection of this application shall be subject to the attached claims.

What is claimed is:

1. A unmanned aerial vehicle (UAV), comprising:
arms; and
a lens assembly, the lens assembly comprising a first lens and a second lens,
wherein the first lens protrudes from a top of a fuselage of the UAV so that the arms are outside an angle of view of the first lens and the second lens protrudes from a bottom of the fuselage of the UAV so that the arms are outside an angle of view of the second lens.

2. The UAV according to claim 1, wherein a UAV body of the UAV has a longitudinal axis along a height direction of the fuselage, and an axis of the first lens or/and an axis of the second lens are relatively inclined to the longitudinal axis so that the UAV body is located outside the angle of view of the first lens and the angle of view of the second lens.

3. The UAV according to claim 2, wherein the arms comprise a first set of arms and a second set of arms, the first set of arms is closer to one side of the fuselage in a length direction relative to the second set of arms; and the first set of arms is closer to the top of the fuselage relative to the second set of arms.

4. The UAV according to claim 3, wherein the axis of the first lens and the axis of the second lens are coaxially arranged and the axis of the first lens is inclined relative to the longitudinal axis in a direction from the first set of arms to the second set of arms.

5. The UAV according to claim 4, wherein an acute angle between the axis of the first lens or the axis of the second lens and the longitudinal axis is in a range of 2 degrees to 10 degrees.

6. The UAV according to claim 3, wherein the axis of the first lens and the axis of the second lens are not coaxially arranged, and the axis of the first lens is inclined relative to the longitudinal axis in a direction from the first set of arms to the second set of arms.

7. The UAV according to claim 6, wherein the axis of the second lens is provided along a direction of the longitudinal axis.

8. The UAV according to claim 6, the axis of the second lens is inclined relative to the longitudinal axis in a direction from the first set of arms to the second set of arms.

9. The UAV according to claim 3, wherein the axis of the first lens and the axis of the second lens are not coaxially arranged, and the axis of the second lens is inclined relative to the longitudinal axis in a direction from the first set of arms to the second set of arms.

10. The UAV according to claim 9, wherein the axis of the first lens is provided along a direction of the longitudinal axis.

11. The UAV according to claim 1, wherein a UAV body of the UAV has a longitudinal axis along a height direction of the fuselage, the axis of the first lens, the axis of the second lens are parallel to the longitudinal axis, and the first lens and the second lens are spaced apart along a length direction of the UAV body so that the UAV body is outside the angle of view of the first lens and the angle of view of the second lens.

12. The UAV according to claim 1, wherein a boundary of the angle of view of the first lens is tangent to a UAV body of the UAV or/and a boundary of the angle of view of the second lens is tangent to the UAV body of the UAV.

13. The UAV according to claim 4, wherein the UAV comprises a connector, one end of the connector is connected to the first lens, and the other end of the connector is connected to the second lens.

14. The UAV according to claim 13, wherein the connector comprises a connecting shaft and a positioner, two ends of the connecting shaft being connected to the first lens and the second lens respectively, and the positioner is disposed in the UAV body to fix the connecting shaft.

15. The UAV according to claim 14, wherein the positioner is a threaded structure, and the threaded structure abuts against the connecting shaft.

16. The UAV according to claim 15, wherein the UAV body comprises a through hole, the threaded structure is a bolt, and the bolt passes through the through hole to abut against the connecting shaft.

17. The UAV according to claim 1, wherein the angle of view of the first lens is at least 185 degrees, and the angle of view of the second lens is at least 185 degrees.

18. The UAV according to claim 1, wherein the angle of view of the first lens is in a range of 185 degrees to 210 degrees, and the angle of view of the second lens is in a range of 185 degrees to 210 degrees.

19. The UAV according to claim 1, wherein the angle of view of the first lens is different from or same as the angle of view of the second lens.
